(19) United States
(12) Patent Application Publication
(10) Pub. No.: US 2026/0032454 A1
(43) Pub. Date: Jan. 29, 2026

(54) ANTENNA DEVICE WITH SMART ANTENNA DEVICE AND WIRELESS DEVICE

(71) Applicant: HEWLETT PACKARD ENTERPRISE DEVELOPMENT LP, Spring, TX (US)

(72) Inventors: Hailong Bai, Beijing (CN); Kuanyue Li, Beijing (CN); Hongli Zhang, Beijing (CN); Jiguang Zheng, Beijing (CN); Xuguang Jia, Beijing (CN)

(21) Appl. No.: 18/784,119

(22) Filed: Jul. 25, 2024

(51) Int. Cl. H04W 16/14; H04W 16/28

(52) U.S. Cl. CPC H04W 16/14; H04W 16/28

(57) ABSTRACT

Implementations of the present disclosure relate to a method implemented at a wireless device. In this method, the wireless device transmits first information related to the position, orientation and a part number of the antenna of the wireless device to an automatic frequency coordination (AFC) system, and the part number is related to the radiation pattern envelope (RPE) of the antenna. Then, the wireless device can receive second information related to the RF signal coverage of the antenna from the AFC system, wherein the RF signal coverage is determined by the AFC system based on the received first information and the transmitting power of the wireless device. Then, the wireless device can adjust at least one angle and/or transmitting power of the antenna based on the second information so that the RF signal coverage of the antenna does not overlap with the RF signal coverage of the adjacent antenna.

### BACKGROUND

Generally, to avoid interference with existing licensed point-to-point devices, wireless access points operating in unlicensed frequencies need to check the Automatic Frequency Coordination (AFC) system before operation. Automatic Frequency Coordination (AFC) is a technology used in wireless communication systems to share spectrum between multiple network operators. To avoid interfering with existing licensed point-to-point devices, unlicensed or registered wireless access points operating on a certain frequency are required to check the AFC system before operation.

This technology allows devices to automatically select and manage spectrum when communicating to avoid interfering with each other. The AFC system uses data from all licensed or registered devices currently operating in, for example, the 6 GHz band, and coordinates the use of shared spectrum between these registered devices and unregistered devices so that their radio frequency coverage does not interfere or overlap.

### BRIEF DESCRIPTION OF THE DRAWINGS

Through the following detailed descriptions with reference to the accompanying drawings, the above and other objectives, features, and advantages of the example implementations disclosed herein will become more comprehensible. In the drawings, several example implementations disclosed herein will be illustrated in an example and in a non-limiting manner, where:

FIG. 1A illustrates a schematic diagram illustrating an example environment in which example implementations of the present disclosure may be implemented;

FIG. 1B illustrates a schematic diagram illustrating connection between an access point (AP) and an antenna device comprised in a wireless device in accordance with some example implementations of the present disclosure;

FIG. 2 illustrates a schematic diagram illustrating an access point and an antenna device comprised in a wireless device in accordance with some example implementations of the present disclosure;

FIG. 3 illustrates a schematic diagram of an equivalent isotropic radiated power and a radio frequency signal heat map of an antenna in accordance with some example implementations of the present disclosure;

FIG. 4 illustrates a schematic flow chart of a method implemented in a wireless device in accordance with some example implementations of the present disclosure;

FIG. 5 illustrates a schematic diagram of antenna alignment of two access points in accordance with some example implementations of the present disclosure;

FIG. 6 illustrates a schematic diagram showing a process of antenna alignment implemented in an AFC system in accordance with some example implementations of the present disclosure; and

FIG. 7 illustrates an example wireless device in accordance with some example implementations of the present disclosure.

### DETAILED DESCRIPTION

In the proposed rules for the Wi-Fi 6 GHz band, the FCC (Federal Communications Commission) sought comments on antenna directivity in automatic frequency coordination AFC calculations to improve spectrum efficiency. That is, it is expected that the coverage of the antenna will be directional, so that the directionality can be used to make some decisions when coordinating the use of shared spectrum between registered and unregistered devices. However, traditional wireless access point antenna devices cannot meet this requirement because they are completely passive components. Therefore, in order to ensure that there is no interference or conflict between the newly added wireless access point and the licensed large devices, professional installers are required to install the antenna of the wireless access point. If the antenna is not installed correctly, the wireless access point may not work.

In addition, if the AFC system finds that the coverage of an unregistered device overlaps with the coverage of another registered device, the AFC system will typically reduce the coverage of the unregistered device, that is, it will reduce its effective isotropic radiated power (EIRP) within the AFC regulations so that its radiation range does not overlap with the existing radiation range.

In addition, in some cases, the deployment of external antennas requires most customers to spend a lot of time measuring and estimating the attenuation of related radio frequency (RF) cables using measurement equipment and manually compensating the antenna gain in the configuration file to comply with regulations. Sometimes, unintentional input errors can even lead to non-compliance issues. However, in most cases, even if the requirements of “professional installers” are met, some steps may be missed and data may not be entered correctly, which may lead to non-malicious non-compliance, that is, unintentional input errors may even lead to non-compliance issues.

Currently when APs are deployed and these APs use extended RF cables, the RF cabling loss needs to be accurately calculated or measured. However, inaccurate RF cabling loss introduces a source of error, thereby unknowingly making the AP non-compliant. In other cases, aligning antenna main lobes in the field for P2P (point-to-point) and point-to-multipoint wireless network deployments has always been a challenge, especially when there is no visibility between antennas.

In order to solve at least one of the problems in the conventional design, the present disclosure provides a method implemented on a wireless device. In this method, the wireless device transmits first information related to the position, orientation, and part number of the antenna of the wireless device to an automatic frequency coordination (AFC) system, and the part number is related to the radiation pattern envelope (RPE) of the antenna. Then, according to the method, the wireless device can receive second information related to the RF signal coverage of the antenna from the AFC system, wherein the RF signal coverage of the antenna is determined by the AFC system based on the received first information and the transmitting power of the wireless device. After receiving the second information, the wireless device can adjust at least one angle and/or transmitting power of the antenna based on the second information so that the RF signal coverage of the antenna does not overlap with the RF signal coverage of the adjacent antenna.

In the method according to the present disclosure, when the AFC system receives information related to the position, orientation, and radiation pattern envelope of the antenna, it can calculate the RF signal coverage of the antenna and can determine whether its coverage overlaps with the coverage of the authorized device. The wireless device can adjust the angle and/or signal strength of the antenna so that its coverage does not overlap with the coverage of the authorized device. Therefore, no professional installers are required to install the antenna, and the wireless device can have more channel availability and better coverage.

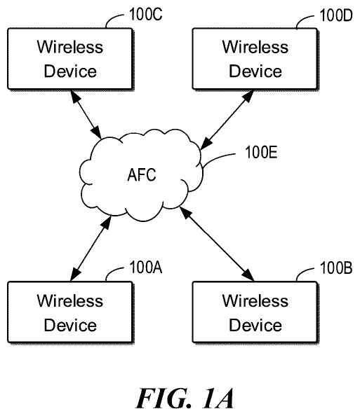

FIG. 1A illustrates a schematic diagram illustrating an example environment in which example implementations of the present disclosure may be implemented. As shown in FIG. 1A, AFC is a technology of automatic frequency coordination, which is used for spectrum sharing between multiple network operating entities in wireless communication systems. To avoid interfering with existing licensed point-to-point devices, unlicensed or registered wireless access points (e.g., wireless devices 100A and 100B) operating at a certain frequency need to check the AFC system 100E before operation. The AFC system 100E contains data of all licensed or registered devices (e.g., devices 100C and 100D, such as radars) currently operating in, for example, 6 GHz frequency band. The AFC system 100E needs to coordinate the use of shared spectrum between these registered devices and unregistered devices so that their RF coverage areas do not interfere or overlap.

FIG. 1B illustrates a schematic diagram illustrating connection between an access point (AP) and an antenna device comprised in a wireless device in accordance with some example implementations of the present disclosure.

As illustrated in FIG. 1B, the wireless device 100A or 100B includes an AP 101 and an antenna device 102. Communications between the AP and the wireless-capable devices may operate according to wireless communication protocols such as the Institute of Electrical and Electronic Engineers (IEEE) 802.11 standards, Wi-Fi Alliance Specifications, or any other wireless communication standards. The IEEE 802.11 standards may include the IEEE 802.11 ay standard (e.g., operating at 60 GHZ), the IEEE 802.11ad standard (sometimes referred to as “WiGig”), the IEEE 802.11be (referred to as “WIFI 7”) or any other wireless communication standards.

As illustrated in FIG. 1B, the antenna device 102 is provided with at least one directional antenna 102A and 102B (such as a passive 6 GHz antenna) and at least one sensor 170 to sense the height, downtilt, heading or azimuth, and the like of the 6 GHz antenna. The at least one sensor 170 is required to be powered by electrical power from the AP 101. The I²C interface is usually a powerful bus used for communication between a master (or multiple masters) and a single or multiple slave device(s). The physical I²C interface consists of the serial clock (SCL) and serial data (SDA) lines. As illustrated in FIG. 1B, the AP 101 includes a clock line 110, such as an SCL line of the I²C interface; and a data line 140, such as an SDA line of the I²C interface. The clock line 110 is configured to transmit or generate a clock signal having alternate high power level and low power level. The clock signal may be transmitted to at least one sensor 170 provided on the antenna device 102 so as to sample the data sensed by the sensor 170. The SDA line 140 is configured to send a request to the sensor to request data sensed by the sensor 170 and then receive the sensed data from the sensor 170, such as information related to the position, the direction, and the coverage area of the directional antenna 102A or 102B.

Continue to refer to FIG. 1B, the AP 101 further includes a first power supply 120A and a second power supply 120B. The first power supply 120A may be a power supply for providing a high voltage, for example, 5V, and the second power supply 120B may be a power supply for providing a low voltage, for example, 4.2V. As illustrated in FIG. 1B, the wireless device 100A or 100B further includes two RF cables 150 and 160 for powering the antenna and transmitting data between the AP and the antenna to avoid the risk of water leakage.

Referring back to FIG. 1B, the AP 101 further comprises a modulator 130 connected to the clock line 110, the first power supply 120A, and the second power supply 120B so as to receive the clock signal and the power voltages. The modulator 130 is configured to modulate the clock signal and the power voltages into a single modulated power. Since the clock signal has alternate high voltage and low voltage, the modulated power has high power voltage and low power voltage alternated with each other.

The modulated power is transmitted to the antenna device 102 over the radio cable 150 so as to power the sensor 170. Since the modulated power cannot be used as the clock signal for the sensed data of the sensor 170, as illustrated in FIG. 1B, the antenna device 102 further includes a demodulator 180 connected to the radio cable 150 and configured to receive and demodulate the modulated power into a demodulated clock signal. The demodulated clock signal is then received by the sensor 170 so as to sample the sensed data. As illustrated in FIG. 1B, the antenna device 102 is further provided with a Low Dropout Regulator (LDO) 190 configured to receive the modulated power and transform the alternate high voltage and low voltage to a constant voltage, for example, 3.3V, which is to be supplied to the sensor 170 to power it.

Therefore, In the AP 101, SDA (data line 140 of the I²C bus of FIG. 1B) is fed to the RF cable 160 through the RF choke inductor. The DC power supply (4.2V and 5V in this example) is modulated into a modulated power supply voltage by SCL (clock line 110 of the I²C bus) via the modulator 130 of FIG. 1, and then fed to the RF cable 150 as shown in FIG. 1A through the RF choke inductor. In the antenna device 102, the modulated power supply voltage is demodulated into a demodulated voltage by the comparator or demodulator 180), and the power supply of the sensor 170, analog-to-digital converter, and EEPROM may be adjusted by the LDO 190.

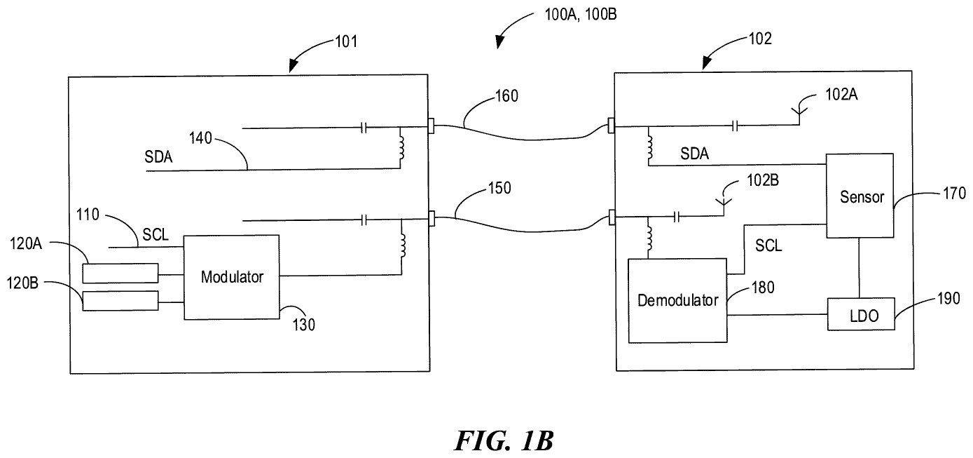

FIG. 2 shows a schematic diagram of the connection between the access point and the antenna device according to an implementation of the present disclosure. As shown in FIG. 2, the AP 201 is connected to the antenna device 202 via the RF cables 260 and 250. The antenna device 202 may be provided on a 3D turntable205, and the AP 201 is connected to the 3D turntable 205 via an internet cable 206. In order to enable the antenna device 202 to report the position, orientation and other information of the antenna, the antenna device 202 is provided with a smart antenna module (SAM) 203 as an accessory of the antenna device 202. The SAM 203 may integrate Electrically Erasable Read-Only Memory (EEROM), barometer, accelerometer, magnetometer and RF power detector into one package. As illustrated in FIG. 2, the smart antenna module 203 may automatically report the height, downtilt, azimuth and radio transmitting power and the like of the antenna 200A or 200B using an integrated barometer, accelerometer, magnetometer and RF (RF) power detector, and the total cost is quite low. The SAM 203 may also report the antenna part number (PN) to the AP 201, and the PN may comprise information such as antenna gain, beam characteristics, directivity and omnidirectionality.

Using the SAM 203 in a radio system can further enhance the channel availability of the 6 GHz band in a standard power (SP) access point (AP) to achieve AFC (automatic frequency coordination) adjustment and achieve contactless installation. The SAM 203 may also be applied to other radio systems, such as dedicated 5G, Citizen Broadband Wireless Service CBRS radio and the like.

As shown in FIG. 2, a GNSS receiver 204 is provided on the AP 201 to report the position of the AP 201 and the antenna device 202. An algorithm may be constructed that may use the GNSS signal level to calculate the building entry loss value. Inside a building, the GNSS signal is often weak or cannot be directly received. By calculating the building entry loss value and taking corresponding compensation measures (such as using differential positioning, multipath error compensation, etc.), the positioning accuracy of the GNSS signal in an indoor environment may be enhanced, thereby making the reported position of the antenna device and the AP more accurate.

The AP 201 may report the PN of the antenna 200A and 200B to the AFC system 207. In some implementations, the AFC system 207 can use the antenna PN to search for the corresponding antenna radiation pattern envelope (RPE) in its database or external resources. In this implementation, the antenna PN may include relevant information such as the antenna's directivity (omnidirectional or directional), antenna gain, and beam characteristics and the like. If the antenna is a standard product and the manufacturer provides corresponding technical documents or data sheets, it is likely that its radiation pattern can be found directly. In other words, reporting the antenna PN to the AFC system means reporting the antenna's RPE to the AFC system. Once the AP obtains and reports the PN to the AFC system, the RPE can be leveraged by the AFC system, which would have the antenna RPE date on fie and on their server.

Antenna RPE is a graphical representation of the antenna's radiation intensity distribution in all directions in space, also known as antenna pattern or radiation pattern. Antenna RPE includes key parameters such as the antenna's radiation directivity (omnidirectional or directional), gain, and beam width. For omnidirectional antennas, they radiate uniformly in all directions, and their RPE is approximately circular or spherical. For directional antennas, they radiate only in specific directions, and their RPE has a higher radiation intensity in the specific direction, while the radiation intensity in other directions is lower.

Antenna gain is a measure of how effectively an antenna concentrates or disperses RF (RF) energy in a specific direction. Antennas with higher gain typically have narrower beams and concentrate more energy in a specific direction. There is also a close relationship between antenna gain and antenna RPE. The antenna gain directly reflects the directivity and concentration of the antenna radiation pattern. The higher the gain, the more concentrated the antenna's radiation energy is in a specific direction, which is usually manifested as a narrower main lobe and smaller side lobes. On the contrary, if the antenna gain is low, it means that its radiation energy is relatively evenly distributed in all directions, and the main lobe of the radiation pattern is wider and the side lobes are larger. Therefore, an antenna RPE in 3D space is related to the orientation information (e.g., downtilt, and azimuth, and the like) at which the antenna is installed and the position of the antenna in 3D space.

As mentioned above, the AP 201 may also send information related to the position of antenna to the AFC system 207. When the position of antenna in 3D space is known, the AFC system 207 may determine the antenna's RPE at that 3D position. The position of antenna may be related to height, longitude, and latitude. The height may be obtained by the sensor in the SAM 203, and the longitude and latitude information may be obtained by the GNSS receiver 204. The orientation of the antenna (e.g., downtilt, azimuth (also called heading angle), etc.) may be obtained by sensors in the SAM 203.

In addition, the AP 201 may also report its own transmitting power and other information to the AFC system 207. The calculated or sent transmitting power is also related to the radiation loss of the RF cable. Using the transmitting power and the antenna RPE at the antenna position obtained above, the AFC system 207 may calculate the equivalent isotropic radiated power (EIRP) of the antenna. EIRP is a measure of the power radiated by an omnidirectional antenna (an antenna that radiates uniformly in all directions) when it produces the same field strength as the actual antenna at a given distance. It takes into account the transmitting power of the AP 201, antenna gain (the antenna gain is, for example, the maximum gain in each direction), and any cable or feeder losses. That is, using the transmitting power, antenna gain, and radiation pattern information, the EIRP in all directions may be calculated, then the RF Signal strength heat map may be generated. This allows the user and the AFC to know the real RF signal strength in the field. Additionally, with a 3D turntable, the antenna downtilt and azimuth can be adjusted to provide per-radio, per-BSS or per-Client level of TX power control to avoid collision, so the directional AFC regulation can be performed.

Therefore, the WLAN antennas and radio systems with the SAM (Smart Antenna Module) according to the present disclosure can automatically report the height, tilt, direction, and radio transmit power by using the integrated Barometer, Accelerometer, Magnetometer and RF power detector, in a total low cost. With SAM in radio system, the channel availability of 6 GHz band in Standard Power (SP) Access point (AP) can be further enhanced for AFC regulation, achieves the no-touch installation.

In some cases, the deployment of external antennas requires a lot of time to measure and estimate the attenuation of the relevant RF (RF) cables through measurement equipment, and manually compensate the antenna gain in the configuration file to comply with regulations. Sometimes, unintentional input errors may even lead to non-compliance issues. However, in most cases, even if the requirements of “professional installers” are met, data (such as data related to the attenuation of RF cables) may not be entered correctly, which may lead to non-malicious non-compliance, that is, unintentional input errors may even lead to non-compliance issues.

Referring back to FIG. 2, in the AP system according to the implementation of the present disclosure, the SAM 203 is able to report transmitted RF power of the antenna 200A or 200B to the AP 201. For example, the SAM 203 may also accurately reflect the RF power level to the AP 201 through the RF cable 250 or 260 of I²C bus. The I²C bus, DC power supply, and RF signal transmission are realized through the RF cables.

Then the AP 201 is able to calculate the attenuation or loss of RF cable based on the RF power transmitted by its transmitter (i.e., RF chip) at its transmitting port and the actual RF power reported by the SAM 203. That is, the AP 201 may calculate cable loss by subtracting the power reported by SAM from the power of AP transmitter, which almost eliminates all sources of error. In addition, if a bad antenna or an incorrect antenna is installed, an error will be reported, thereby further protecting regulatory compliance.

Therefore, the automatic RF cable loss measurement of the AP system according to the present disclosure will not introduce sources of error that could unknowingly take APs out of compliance, and may ensure Wi-Fi Tx power balance across the chain, and there is no need for measuring and estimating the attenuation of the related RF (radio frequency) cables via measurement equipment and the need for compensating with the antenna gain manually in the configuration file to comply with the regulations.

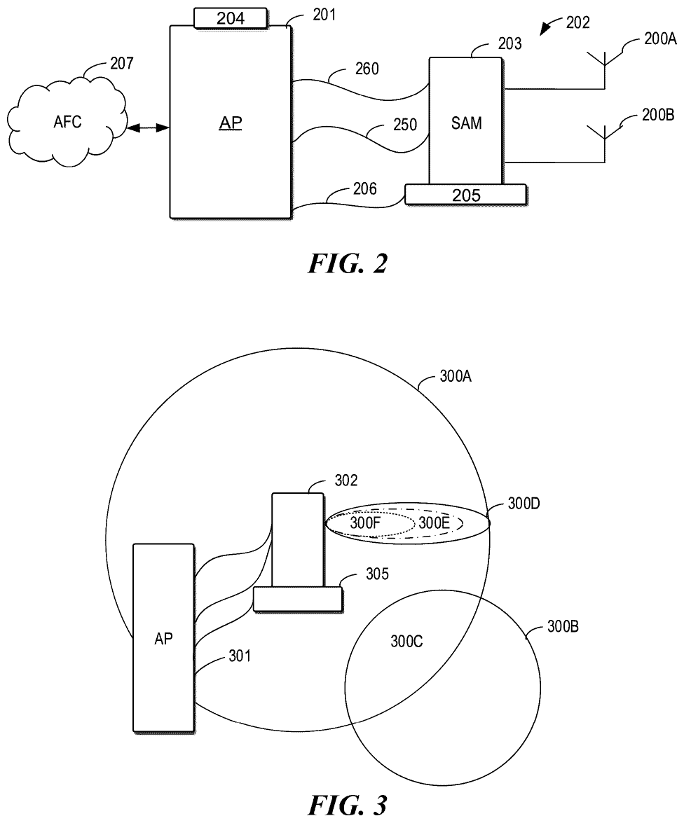

FIG. 3 illustrates a schematic diagram of EIRP and a RF signal heat map of an antenna in accordance with some example implementations of the present disclosure. As shown in FIG. 3, the large circular area 300A represents the EIRP, and the elliptical areas 300D, 300E, and 300F represent the RF signal strength heat map. The RF signal strength heat map is an indication of the power of the transmitting antenna in a given direction. It reflects the signal coverage and strength distribution of the antenna in the actual application environment. It takes into account the antenna gain (e.g., maximum gain) and the power output of the transmitter. The generated heat map of RF signal strength helps to ensure compliance with regulatory limits on RF emissions.

Different elliptical areas represent different signal transmitting powers. FIG. 3 only shows a plan view of the coverage. In fact, the coverage is a three-dimensional range, that is, the circle is actually a sphere and the elliptical area is actually an ellipsoid. Therefore, once the EIRP in all directions and the orientation of the antenna are known, a heat map of RF signal strength may be generated. By combining EIRP with antenna orientation, the signal strength in a specific direction and at a specific distance may be calculated, that is, a heat map of RF signal strength may be obtained.

Therefore, based on the first information related to the position, orientation and RPE of the antenna obtained by the AFC system, the second information related to the RF signal coverage of the antenna may be calculated using this information, and the second information is associated with the heat map of RF signal strength. In the case of obtaining the heat map of RF signal strength, the AFC system may determine whether the heat map of the antenna overlaps with the coverage of an existing authorized device (for example, radar).

As shown in FIG. 3, it may be seen that there is no overlap between the coverage of the antenna (i.e., the elliptical area, 300D, 300E, and 300F) and the coverage 300B of the authorized device, so the antenna may work in this state. In a traditional AFC system, the AFC system regards all antennas as isotropic communication, so the coverage generated for the antenna is shown as a large circle 300A, so there is an overlap area 300C with the coverage 300B of the authorized device. Therefore, according to traditional supervision, the transmitting power of the AP needs to be backed off to the power represented by the smallest ellipse 300F, so that there is no overlap between the coverage shown by the ellipse 300F and the coverage 300B of the authorized device. However, in the AP system according to the present disclosure, since the RF signal strength heat map of the antenna 302 (i.e., a more accurate signal coverage) is obtained, it may be seen from FIG. 3 that there is no overlap between its coverage 300D, 300E, and 300F and the coverage 300B of the authorized device, so the antenna may transmit the signal with the power represented by the largest ellipse 300D.

As illustrated in FIG. 3, the antenna device 302 is mounted on a 3D turntable 305, or in other words, the antenna device 302 may change its direction or orientation through 3D turntable. When the AP 301 receives an indication result related to the second information (e.g., an indication of whether there is a coverage overlap), the AP 301 may determine whether it is necessary to change the orientation or direction of the antenna device, or the AFC system may determine the rotation angle of the 3D turntable 305 and send the indication to the AP 301. When it is necessary to change the orientation or direction of the antenna device, a command may be sent to the 3D turntable 305 to change the orientation or direction of the antenna, for example, through an ethernet cable. In some other implementations, the adjustment amount of the transmitting power of each transmission port may be calculated or determined so as to change the RF signal heat map.

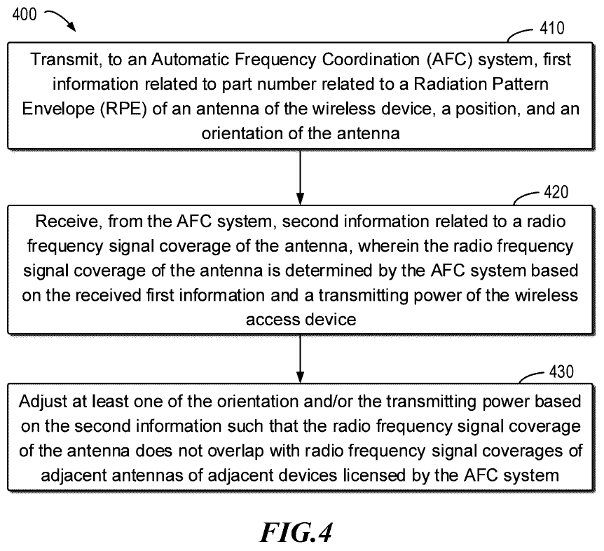

FIG. 4 shows a schematic diagram of a method implemented on a wireless device according to some implementations of the present disclosure In block 410, first information related to a position, an orientation and a part number of an antenna of a wireless device related to an RPE of the antenna may be transmitted to the AFC system. As described above, when the PN, position and orientation of the antenna are obtained, the RPE of the antenna in three-dimensional space, that is, the radiation pattern, may be obtained. The position of the antenna may be obtained from the GNSS receiver on the AP, and the orientation information of the antenna may be obtained from the sensor of the SAM on the antenna device. When the PN of the antenna is obtained, the AFC system may retrieve the RPE data of the antenna in its database, so as to obtain the RPE of the antenna in three dimensions.

At block 420, second information related to a RF signal coverage of the antenna may be received from the AFC system, and the RF signal coverage of the antenna is determined by the AFC system based on the received first information and a transmitting power of the wireless device. When the transmitting power and the 3D RPE of the antenna are known, the RF signal coverage, that is, the RF signal strength heat map may be obtained. At block 430, at least one of the orientation, and/or the transmitting power may be adjusted based on the second information such that the RF signal coverage of the antenna does not overlap with RF signal coverages of adjacent antennas of adjacent devices licensed by the AFC system. That is to say, in order to make the RF signal coverage of the wireless device not overlap with the RF signal coverage of the authenticated device, at least one of the orientation of the antenna or the transmitting power of the wireless device may be adjusted.

In the method 400 according to the present disclosure, when the AFC system receives information related to the position, orientation, and radiation pattern envelope of the antenna, it can calculate the RF signal coverage (i.e., RF signal strength heatmap) of the antenna and can determine whether its coverage overlaps with the coverage of the authorized device. The wireless device can adjust the angle and/or signal strength of the antenna so that its coverage does not overlap with the coverage of the authorized device. Therefore, no professional installers are required to install the antenna, and the wireless device can have more channel availability and better coverage.

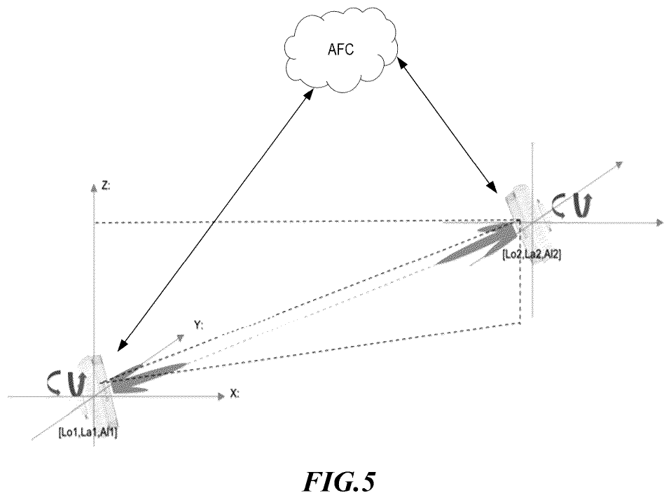

In some cases, it is always a challenge to align the main lobe of the antenna on site for P2P (point-to-point) and point-to-multipoint wireless network deployment, especially when there is no visibility between the antennas. If two APs need to communicate, their main lobes or narrow beams need to point to each other, as shown in FIG. 5. For example, the longest beams (i.e. the main lobes of each antenna) as shown in FIG. 5 are required to pointed to each other so as to transmit data to each other. The AP system according to the present disclosure may enable point-to-point antenna/radio alignment to be reduced from hours to minutes, thereby significantly improving the customer experience.

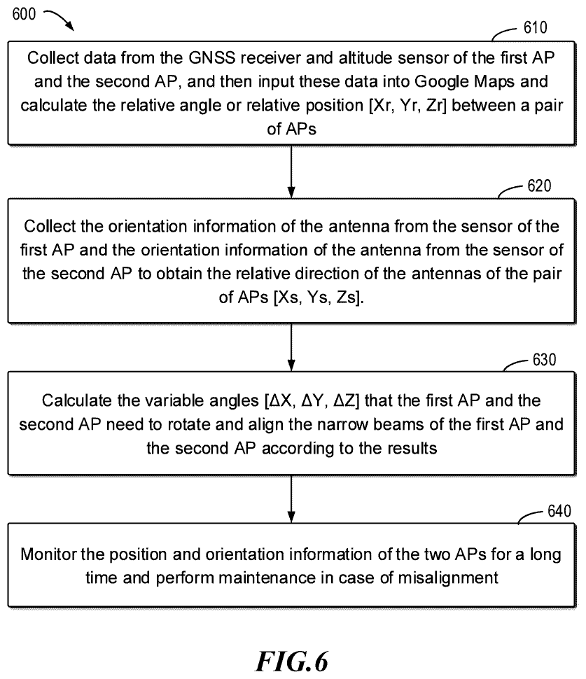

FIG. 6 illustrates a schematic diagram 600 showing a process of antenna alignment implemented in an AFC system in accordance with some example implementations of the present disclosure. As shown in FIG. 6, with the help of GNSS positioning, antenna orientation information of outdoor AP pairs, and support from a 3D turntable, the controller in the AFC system may efficiently and accurately align the narrow beams of the APs with each other.

At block 610, the controller in the AFC system may collect data from the GNSS receiver and height sensor of the first AP and the second AP, and then input these data into Google Maps and calculate the relative angle or relative position [Xr, Yr, Zr] between a pair of APs. At block 620, the controller in the AFC system collects the orientation information of the antenna from the sensor of the first AP and the orientation information of the antenna from the sensor of the second AP to obtain the relative direction of the antennas of the pair of APs [Xs, Ys, Zs].

At block 630, the controller in the AFC system calculates the variable angles [ΔX, ΔY, ΔZ] that the first AP and the second AP need to rotate and aligns the narrow beams of the first AP and the second AP according to the results. At block 640, the controller in the AFC system monitors the position and orientation information of the two APs for a long time and performs maintenance in case of misalignment.

For example, magnetic field distortion caused by ferromagnetic and high permeability objects will reduce accuracy, such as iron ore, reinforced concrete buildings, iron poles close to the magnetometer, etc. In some implementations of the present disclosure, some experiments were conducted to verify the SAM function and performance. The experiments are conducted at operating temperatures between 15° C. (59° F.) and 45° C. (113° F.), and the first year after production (calibration).

The results are shown in the following Table 1.

TABLE 1
Performance Test

| Measurement Parameters | Accuracy | |
|---|---|---|
| Height | ±0.9 | m |
| Downtilt | ±5 | degrees |
| Azimuth | ±7 | degrees |
| RF Power | ±0.5 | dB |
| GPS Position | ±5 | m |

According to the table, it can be seen that the functions and performance of SAM can remain relatively stable during long-term use. Through these measurements, the measurement results of SAM can also be calibrated accordingly.

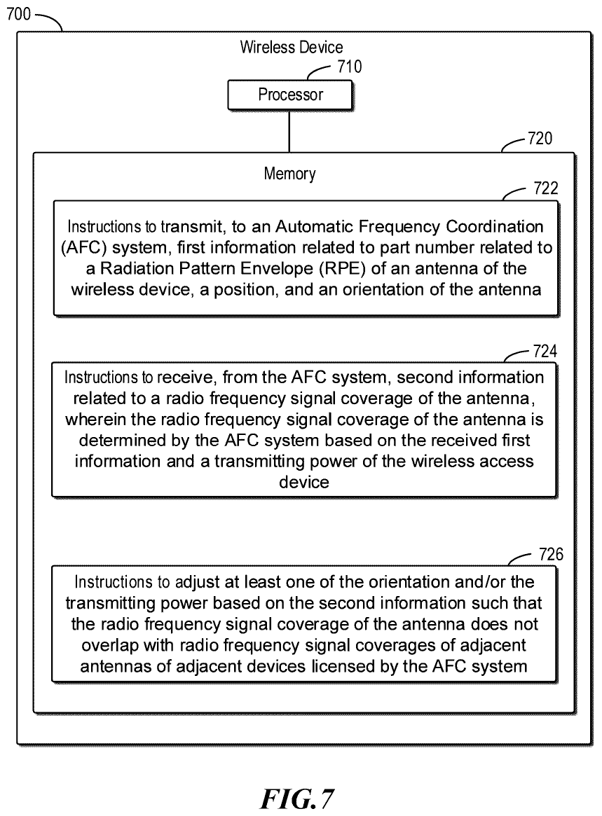

Reference is made to FIG. 7, which illustrates an example wireless device 700 according to implementations of the present disclosure. As shown in FIG. 7, the wireless device 700 comprises at least one processor 710, and a memory 720 coupled to the at least one processor 710. The memory 720 stores instructions 722, 724 and 726 to cause the processor 710 to perform actions according to example implementations of the present disclosure. As shown in FIG. 7, the memory 720 stores instructions 722 to transmit, to an AFC system, first information related to a position, an orientation, and a part number of an antenna of a wireless device related to an RPE of the antenna. The memory 720 further stores instructions 724 to receive, from the AFC system, second information related to a RF signal coverage of the antenna, and the radio frequency signal coverage of the antenna is determined by the AFC system based on the received first information and a transmitting power of the wireless device.

The memory 720 further stores instructions 726 to adjust at least one of the orientation, and/or the transmitting power based on the second information such that the RF signal coverage of the antenna does not overlap with RF signal coverages of adjacent antennas of adjacent devices licensed by the AFC system. The stored instructions and the functions that the instructions may perform can be understood with reference to the description of FIGS. 2-6. For the purpose of simplification, the details of instructions 722, 724, and 726 will not be discussed herein.

Similar, by implementing the instructions 722, 724, and 726, the wireless device may transmit first information related to the position, orientation and part number of the antenna of the wireless device to an automatic frequency coordination (AFC) system, and the part number is related to the radiation pattern envelope (RPE) of the antenna. After receiving the information related to the position, orientation and radiation pattern envelope of the antenna, the AFC may calculate the real RF signal coverage of the antenna and can determine whether its coverage overlaps with the coverage of the authorized device, and transmit the determined result to the wireless device. Then, the wireless device can adjust the angle and/or transmitting power so that its coverage does not overlap with the coverage of the authorized device. Therefore, no professional installers are required to install the antenna, and the wireless device can have more channel availability and better coverage. Other advantages of implementations will not be discussed again for the sake of simplification.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed is:

1. A method, comprising:
transmitting, by a wireless device to an Automatic Frequency Coordination (AFC) system, first information related to part number associated with Radiation Pattern Envelope (RPE) of an antenna of the wireless device, a position, and an orientation of the antenna;
receiving, by the wireless device from the AFC system, second information related to a radio frequency signal coverage of the antenna, wherein the radio frequency signal coverage of the antenna is determined by the AFC system based on the received first information and a transmitting power of the wireless device; and
adjusting, by the wireless device, at least one of the orientation, and the transmitting power based on the second information such that the radio frequency signal coverage of the antenna does not overlap with radio frequency signal coverages of adjacent antennas of adjacent devices licensed by the AFC system.

2. The method according to claim 1, further comprising:
receiving information related to height of the antenna from a sensor on an antenna device of the wireless device on which the antenna is located;
receiving information related to longitude and latitude of the antenna from a locator installed on a wireless access point of the wireless device; and
determining the position of the antenna in three-dimensional space based on the information related to the height and the information related to the longitude and latitude.

3. The method according to claim 1 further comprising:
receiving information related to downtilt and azimuth of the antenna from a sensor on an antenna device of the wireless device on which the antenna is located; and
determining the orientation of the antenna based on the downtilt and the azimuth.

4. The method according to claim 1, wherein the AFC system is configured to obtain the radiation pattern envelope of the antenna in three-dimensional space based on the received serial number information, the position of the antenna and the orientation of the antenna,
wherein the RF signal coverage of the antenna is determined based on the radiation pattern envelope of the antenna in three-dimensional space and the transmitting power of the wireless device.

5. The method according to claim 1, wherein the wireless device further comprises a turntable, and an antenna device where the antenna is located is mounted on the turntable,
wherein adjusting the orientation of the antenna comprises:
sending an angle adjustment amount to the turntable to rotate the turntable to a specific position.

6. The method according to claim 1, wherein the second information indicates the degree of coverage between the RF signal coverage of the antenna and the RF signal coverage of the adjacent antennas of the adjacent devices.

7. The method according to claim 1, wherein the antenna is mounted on an antenna device, the wireless device further comprises a wireless access point, and the antenna device and the wireless access point are electrically connected via an RF signal cable, the method further comprising:
receiving an indication of a real transmitting power from the antenna device via the RF signal cable; and
determining a loss of the RF signal cable based on a transmitting power at a transmitter of the wireless access point and the indication of the real transmitting power,
wherein the transmitting power of the wireless device is also adjusted based on the loss of the RF signal cable.

8. The method according to claim 1, wherein the wireless device is a first wireless device, the method further comprising:
obtaining information related to an adjustment angle of the first wireless device; and
aligning a main lobe of a first antenna of the first wireless device with a main lobe of a second antenna of the second wireless device to be aligned with the first wireless device based on the adjustment angle.

9. The method according to claim 8, wherein the adjustment angle is determined based on relative position information and relative orientation information between the first antenna of the first wireless device and the second antenna of the second wireless device.

10. The method according to claim 9, wherein both the first wireless device and the second wireless device include an antenna device, wherein the antenna device includes a sensor configured to sense the orientation of the first antenna or the second antenna.

11. A wireless device comprising:
at least one processor; and
a memory coupled to the at least one processor, the memory storing instructions to cause the at least one processor to:
transmit, to an Automatic Frequency Coordination (AFC) system, first information related to part number associated with Radiation Pattern Envelope (RPE) of an antenna of the wireless device, a position, and an orientation of the antenna;
receive, from the AFC system, second information related to a radio frequency signal coverage of the antenna, wherein the radio frequency signal coverage of the antenna is determined by the AFC system based on the received first information and a transmitting power of the wireless device; and
adjust at least one of the orientation and/or the transmitting power based on the second information such that the radio frequency signal coverage of the antenna does not overlap with radio frequency signal coverages of adjacent antennas of adjacent devices licensed by the AFC system.

12. The wireless device according to claim 11, wherein the instructions further cause the at least one processor to:
receive information related to height of the antenna from a sensor on an antenna device of the wireless device on which the antenna is located;
receive information related to longitude and latitude of the antenna from a locator installed on a wireless access point of the wireless device; and
determine the position of the antenna in three-dimensional space based on the information related to the height and the information related to the longitude and latitude.

13. The wireless device according to claim 11, wherein the instructions further cause the at least one processor to:
receive information related to downtilt and azimuth of the antenna from a sensor on an antenna device of the wireless device on which the antenna is located; and
determine the orientation of the antenna based on the downtilt and the azimuth.

14. The wireless device according to claim 11, wherein the AFC system is configured to obtain the radiation pattern envelope of the antenna in three-dimensional space based on the received serial number information, the position of the antenna and the orientation of the antenna,
wherein the RF signal coverage of the antenna is determined by the AFC system based on the radiation pattern envelope of the antenna in three-dimensional space and the transmitting power of the wireless device.

15. The wireless device according to claim 11, wherein the wireless device further comprises a turntable, and an antenna device where the antenna is located is mounted on the turntable,
wherein the instructions to adjust the orientation of the antenna cause the at least one processor to:
send an angle adjustment amount to the turntable to rotate the turntable to a specific position.

16. The wireless device according to claim 11, wherein the second information indicates the degree of coverage between the RF signal coverage of the antenna and the RF signal coverage of the adjacent antennas of the adjacent devices.

17. The wireless device according to claim 11, wherein the antenna is mounted on an antenna device, the wireless device further comprises a wireless access point, and the antenna device and the wireless access point are electrically connected via an RF signal cable, and
the instructions further cause the at least one processor to:
receive an indication of a real transmitting power from the antenna device via the RF signal cable; and
determine a loss of the RF signal cable based on a transmitting power at a transmitter of the wireless access point and the indication of the real transmitting power,
wherein the transmitting power of the wireless device is also adjusted based on the loss of the RF signal cable.

18. The wireless device according to claim 11, wherein the wireless device is a first wireless device, and
the instructions further cause the at least one processor to:
obtain information related to an adjustment angle of the first wireless device; and
align a main lobe of a first antenna of the first wireless device with a main lobe of a second antenna of the second wireless device to be aligned with the first wireless device based on the adjustment angle.

19. The wireless device according to claim 18, wherein the adjustment angle is determined based on relative position information and relative orientation information between the first antenna of the first wireless device and the second antenna of the second wireless device.

20. A non-transitory computer-readable medium comprising instructions stored thereon which, when executed by a wireless device, cause the wireless device to:
transmit, to an Automatic Frequency Coordination (AFC) system, first information related to a position, an orientation and a part number of an antenna of a wireless device related to a Radiation Pattern Envelope (RPE) of the antenna;
receive, from the AFC system, second information related to a radio frequency signal coverage of the antenna, wherein the radio frequency signal coverage of the antenna is determined by the AFC system based on the received first information and a transmitting power of the wireless device; and
adjust at least one of the orientation and/or the transmitting power based on the second information such that the radio frequency signal coverage of the antenna does not overlap with radio frequency signal coverages of adjacent antennas of adjacent devices licensed by the AFC system.
